(19) United States
(12) Patent Application Publication
(10) Pub. No.: US 2025/0027357 A1
(43) Pub. Date: Jan. 23, 2025

(54) INSTALLATION FACILITATOR FOR FRAMED FIXTURE

(71) Applicant: Frank Joseph Tortorella, JR., Park Ridge, IL (US)

(72) Inventor: Frank Joseph Tortorella, JR., Park Ridge, IL (US)

(21) Appl. No.: 18/779,721

(22) Filed: Jul. 22, 2024

Related U.S. Application Data
(60) Provisional application No. 63/515,115, filed on Jul. 23, 2023.
(60) Provisional application No. 63/603,624, filed on Nov. 28, 2023.

(51) Int. Cl. E06B 1/60

(52) U.S. Cl. CPC E06B 1/6069

(57) ABSTRACT

Disclosed are solutions for an installation facilitation system for installation of fixtures, such as windows or doors, within rough openings. The installation facilitation system includes a facilitator coupled to, or attachable to, a peripheral portion of a fixture, the facilitator including a connection element enabling a mechanical fastener to pass through the connection element to engage an attachment surface adjacent the fixture without insertion of the mechanical fastener through the fixture.

### CROSS-REFERENCE TO RELATED APPLICATIONS

This application claims benefit of and priority to, and incorporates by reference herein in their entirety, U.S. Provisional Application No. 63/515,115, filed Jul. 23, 2023, titled “Windows and Doors Comprising Installation Plug or Plugs” (Attorney Docket No. 20318-10300USPR) and U.S. Provisional Application No. 63/603,624, filed Nov. 28, 2023, titled “Windows and Doors Comprising Installation Facilitator or Facilitators” (Attorney Docket No. 20318-10300USP2).

### BACKGROUND

As known and appreciated by skilled artisan in the building and construction vocations, windows and doors are installed as fixtures that are disposed and fixedly secured—both initially and subsequently as replacements—within a circumscribed opening intended to be engaged by such a fixture of a related shape and size. Such a rough opening—termed such because the surface often comprises exposed interior building materials such as wooden studs, concrete supports, or metal beams used to frame out the circumscribed opening—is typically somewhat larger than the intended fixture to allow for the fixture to be easily disposed and properly installed (e.g., squared, leveled, and plumbed). To achieve a proper installation, shims are commonly used to fixedly fill opportunistic locations in the gaps between the fixture and the physical sides of the opening to moveably adjust and fix the final placement of the fixture within the opening, with a level, square, and shims, and optionally an air wedge, to being used to make sure the window is plum, square, and level. In the conventional installation, the installer selects and marks the drilling points on the frame, selects a drill bit appropriate for the window frame material. Following the marking, the installer drills pilot holes at the marked locations and then drives screws appropriate for the window frame material (e.g., wood screws for wood frames, GRK screws for vinyl window frames, self-tapping screws for aluminum and uPVS frames, self-tapping 316 screw for fiberglass, etc.) through the window casing into the framing around the opening to secure the window, often in order of top, bottom, and then the sides. In some instances, installers will, for convenience in installation, drive a screw through the upper side jamb and into the framing to help hold the window in place while perform the aforementioned steps. The installer then caulks the windows to seal gaps/holes and applies trim between the window and opening.

### SUMMARY

Disclosed herein are various implementations directed to systems and methods for installation of fixtures, such as windows and doors, within circumscribed openings, both as an initial installation and as a replacement installation of a previously installed fixture. The term fixture, used herein, refers to both pre-fabricated fixtures, wherein the installer does nothing but install the fixture, and fixtures for which the installer performs one or more actions, or installs one or more components, to the fixture prior to installation.

More specifically, various implementations disclosed herein are directed to a facilitator apparatus for an installation comprising a facilitator receiver (e.g., a track, a slot, a groove, a flange, a formed passage, engagement connector, engagement region, etc.), a facilitator having a first portion at least substantially conforming to primary dimensions of at least a portion of the facilitator receiver of a fixture to facilitate positioning of the facilitator within, at least partially within, or adjacent the facilitator receiver, and having a second portion (e.g., an engagement member) dimensioned to couple the facilitator to the facilitator receiver, and a facilitator connection element enabling a mechanical fastener to engage an attachment surface adjacent the installed fixture to at least partially affix the fixture to the attachment surface. Via the facilitator, this can be accomplished without a need to drill through the fixture.

Furthermore, various implementations disclosed herein are also directed to an installation facilitation system for a fixture comprising one or more facilitators, disposed at a periphery of the fixture, each of the one or more facilitators including a connection element enabling a mechanical fastener to engage an attachment surface to at least partially affix the fixture to the attachment surface without drilling through the fixture. In some aspects, the present concepts include an installation facilitation system for a fixture comprising a plurality of facilitators, disposed at peripheral portions of the fixture, each of the plurality of facilitators including a connection element enabling a mechanical fastener to engage an attachment surface to at least partially affix the fixture to the attachment surface without drilling through the fixture. In some examples of such an embodiment, a first facilitator could be disposed at a first side of the fixture (e.g., a top side, a bottom side, a left side, or a right side) and a second facilitator could be disposed at a second side of the fixture (e.g., another of the top side, bottom side, left side, or right side). In some examples of such an embodiment, a first facilitator could be disposed at a first side of the fixture (e.g., a top side, a bottom side, a left side, or a right side) and a second facilitator could be also be disposed at the same first side of the fixture. In some examples, a first facilitator is disposed at a first side of the fixture, a second facilitator is disposed at a second side of the fixture, a third facilitator is disposed at a third side of the fixture, and a fourth facilitator is disposed at a fourth side of the fixture. In some examples, a plurality of facilitators (i.e., more than one) are disposed at a first side of the fixture, a plurality of facilitators are disposed at a second side of the fixture, a plurality of facilitators are disposed at a third side of the fixture, and a plurality of facilitators are disposed at a fourth side of the fixture. In some examples, a plurality of facilitators (i.e., more than one) are disposed at one or more sides of the fixture and a single facilitator, or no facilitators, are disposed at one or more other sides of the fixture.

Furthermore, select implementations disclosed herein may also be directed to a method for facilitated installation of a fixture, comprising the acts of coupling a facilitator of a facilitator within a facilitator receiver of the fixture, such as by inserting an facilitator engagement member into a receiver formed in the fixture, and installing a mechanical fastener through a connection element of the facilitator to physically engage an attachment surface to at least partially affix the fixture to the attachment surface without drilling through the fixture.

This summary is provided to introduce a selection of concepts in a simplified form that are further described below in the detailed description. This summary is not intended to identify key features or essential features of the claimed subject matter, nor is it intended to be used to limit the scope of the claimed subject matter, nor is it an admission that any of the information provided herein is prior art to the implementations described herein.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is an illustration providing a cut-away side view of an example fixture in accord with at least some aspects of concepts disclosed herein;

FIG. 2A is an illustration providing a partial cut-away side view of the lower frame portion (LFP) of the example fixture of FIG. 1 in accord with at least some aspects of concepts disclosed herein;

FIG. 2B is an illustration providing a side view of the example LFP in accord with at least some aspects of concepts disclosed herein;

FIG. 3A is an illustration providing an internal side view of an example facilitator apparatus comprising an example parallel facilitator in accord with at least some aspects of concepts disclosed herein;

FIG. 3B is an illustration providing a front view of the example facilitator apparatus of FIG. 3A in accord with at least some aspects of concepts disclosed herein;

FIG. 3C is an illustration providing a perspective view of the example facilitator apparatus of FIGS. 3A-3B in accord with at least some aspects of concepts disclosed herein;

FIG. 4A is an illustration providing a partial cut-away side view of an example dual-facilitator disposed at the LFP attached to an example structure in accord with at least some aspects of concepts disclosed herein;

FIG. 4B is an illustration providing a partial cut-away side view of a dual-facilitator disposed at the frame upper portion (FUP) attached to a structure in accord with at least some aspects of concepts disclosed herein;

FIG. 5A is an illustration providing a side view of an alternative example LFP assembly comprising a second example facilitator in accord with at least some aspects of concepts disclosed herein;

FIG. 5B is an illustration providing a perspective view of the example LFP assembly of FIG. 5A in accord with at least some aspects of concepts disclosed herein;

FIG. 5C is an illustration providing an internal side view of the example LFP assembly of FIG. 5A in accord with at least some aspects of concepts disclosed herein;

FIG. 5D is an illustration providing a top view of the example LFP assembly of FIG. 5A in accord with at least some aspects of concepts disclosed herein;

FIG. 5E is an illustration providing a bottom view of the example LFP assembly of FIG. 5A in accord with at least some aspects of concepts disclosed herein;

FIG. 6A is an illustration providing a cut-away side view of the example second facilitator in accord with at least some aspects of concepts disclosed herein;

FIG. 6B is an illustration providing a partial-perspective side view of the example second facilitator of FIG. 6A in accord with at least some aspects of concepts disclosed herein;

FIG. 6C is an illustration providing an up-from-bottom perspective view of the example second facilitator of FIGS. 6A-6B in accord with at least some aspects of concepts disclosed herein;

FIG. 7 is an illustration again providing a side view of the alternative LFP assembly comprising a second facilitator shown in FIG. 5A with an image of a dimensional map incorporated therein to provide exemplary dimensions for said facilitator in accord with at least some aspects of concepts disclosed herein;

FIG. 8A is an illustration providing a perspective view of an alternative LFP assembly comprising an integrated facilitator in accord with at least some aspects of concepts disclosed herein;

FIG. 8B is an illustration providing an internal side view of the alternative LFP of FIG. 8A in accord with at least some aspects of concepts disclosed herein;

FIG. 8C is an illustration providing a bottom view of the alternative LFP assembly of FIG. 8A in accord with at least some aspects of concepts disclosed herein; and

FIG. 9 is an example process flow diagram illustrating an example approach for facilitated installation of a fixture representative of the various implementations disclosed herein.

### DETAILED DESCRIPTION

An understanding of various concepts is helpful toward a broader and more complete understanding of the various implementations disclosed herein, and skilled artisans will readily appreciate the implications these various concepts have on the breadth and depth of the various implementations herein disclosed. While the several and various implementations disclosed herein may be described as specifically pertaining to or directed to use with windows, doors, and other such fixtures, such implementations may be equally applied to other fixtures and utilized for other related purposes. Accordingly, nothing herein is intended to limit the various implementations solely to windows or doors but, instead, the various implementations disclosed herein may be applied to a variety of different applications, and the disclosures made herein should be read as broadly as possible as applied to a variety of different utilizations.

Certain terms used herein may also be used interchangeably with other terms used herein, and any such terms should be given the broadest interpretation possible unless explicitly noted otherwise.

The innovations described herein enable faster, one-person window installation. In some aspects, the facilitators are pre-attached to the prefabricated structure and simply need to be moved and/or deployed to a position where the facilitator can then itself be securely attached to the rough opening. This innovation simplifies and streamlines the installation process, reducing installation time and attendant complexities associated with conventional installations

The facilitators described herein revolutionize the process of installing windows in both new construction and remodeling applications. The innovative facilitators eliminate the need for drilling into the window frame, thereby improving installation efficiency, ensuring structural integrity, and reducing installation time for both residential and commercial applications. The facilitators disclosed herein also simplify the installation process for various window materials (e.g., wood, vinyl, aluminum, fiberglass, composite, etc.), as the mechanical fasteners themselves no longer need to be optimized for the particular fixture frame material.

The facilitators described herein also enhance the adaptability of installation as installers can easily reposition the facilitators within the window frame to select the strongest and most suitable areas for attachment and enable consistent force distribution, enhancing the durability and longevity of installed windows.

Significantly, the facilitators offer the unique advantage of enabling installation from either the inside or outside. This flexibility allows installers to choose the most convenient and efficient approach based on specific installation scenarios. Whether it is a new construction project or a remodeling application, the facilitators can be employed effectively, saving time and effort. The facilitators also enhance installation efficiency and convenience, with the facilitator connectors (e.g., pre-drilled connection points, etc.) significantly reducing installation time and effort, resulting in increased productivity for installers.

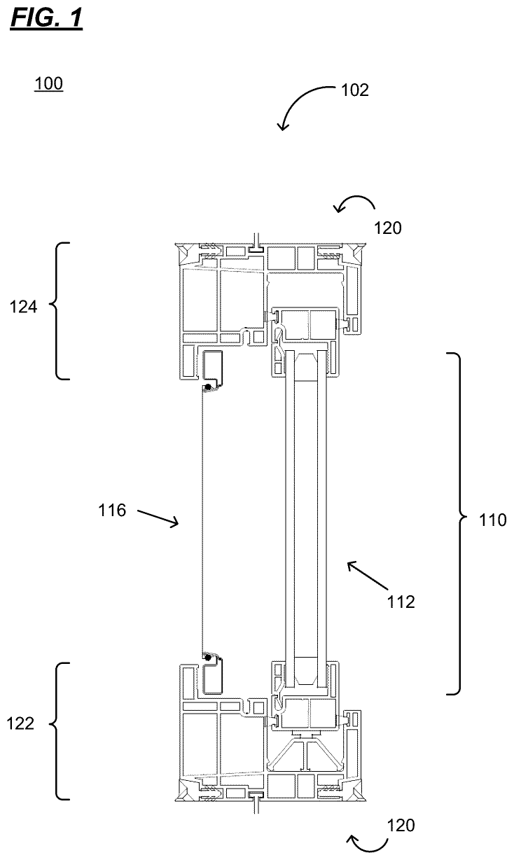

FIG. 1 is an illustration 100 providing a cut-away side view of an example fixture 102 in accord with at least some aspects of concepts disclosed herein. In FIG. 1, the fixture 102 (or simply “fixture”) comprises a frame shown comprising a lower frame portion (LFP) 122 and an upper frame portion (UFP) 124 as well as a left portion (not shown) and a right frame portion (not shown). In general, the use of “left” and “right” herein may be used to refer to a left or right portion of a vantage of a viewer of a figure being referenced or, alternatively, from the vantage of a viewer on an interior (e.g., of a house) viewing the fixture 102 from the interior side, which in FIG. 1 corresponds to the side with the door/window structure 112, whereas the side with the screen structure 116 in FIG. 1 would correspond to the exterior (with “interior” also corresponding to “front” as used herein and “exterior” also corresponding to “back” in like fashion).

In simple terms, the fixture comprises an assembly 110 (e.g., a door or a window structure) surrounded by a frame (e.g., 122 and 124). In FIG. 1, the example assembly 110 comprises a window structure 112 and a screen structure 116 constituting an inner or medial portion of the fixture 102 and generally includes all components not part of the frame. There are also left, right, top, and bottom exterior surfaces 120 of the frame that correspond to the attachment surfaces of the circumscribed opening in which the fixture 102 is disposed.

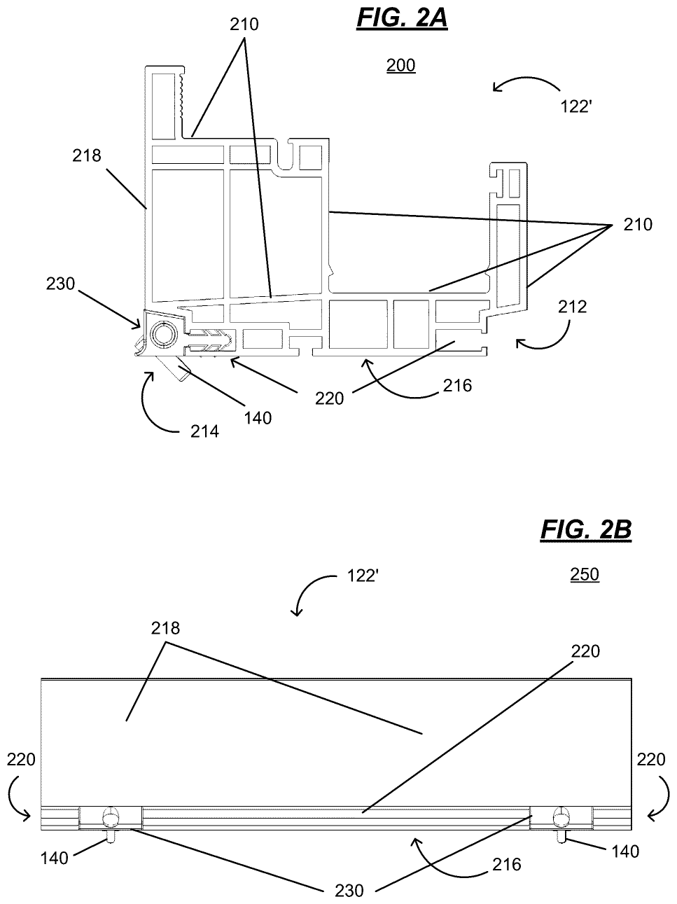

FIG. 2A is an illustration 200 providing a partial cut-away side view of the example lower frame portion (LFP) 122′ corresponding to the LFP 112 of FIG. 1 in accord with at least some aspects of concepts disclosed herein. FIG. 2B is an illustration providing a side view of the LFP 122′ of FIG. 2A in accord with at least some aspects of concepts disclosed herein. FIG. 2A and FIG. 2B may be referred to herein collectively as FIG. 2.

As shown in FIG. 2, much of the frame comprises support structures 210, a bottom side 216, a back side 218. The LFP 122′ also comprises a front facilitator receiver 212 and a back facilitator receiver 214, each further comprising an engagement channel 220. In other aspects of the present concepts, the engagement channel comprises, in lieu of an elongated channel, a plurality of engagement connectors, a plurality of engagement regions, or a plurality of a engagement slots. Also shown in FIG. 2A is a first example installation facilitator 230 (“facilitator”) disposed in the back emplacement receptable 214 and the corresponding engagement channel 220. Also shown is an example mechanical fastener 140 (e.g., a nail, a screw, a threaded fastener, a pin, etc.) inserted into the facilitator 230 through a connection element (e.g., an opening, a directional opening, a hole, a through hole, a blind hole, a tapered hole, a tapped hole, a counterbore, a spotface hole, a pilot hole, one or more pre-formed line(s) of weakness, etc.) provided in the body of the facilitator 230 to secure the facilitator, frame and fixture in place relative to the structure (e.g., rough opening). FIG. 2B also shows an example wherein the engagement channel 220 extends from end-to-end to enable the facilitator(s) 140 to be laterally slidable such that each facilitator 230 can be disposed anywhere along the facilitator receiver 214.

The facilitator, or to a window or door incorporating facilitator(s), comprises pre-drilled connection points or pre-formed (e.g., lines of weakness, pilot holes, etc.) connection points and the facilitator(s) are either strategically positioned within (e.g., static facilitator(s)) and/or selectively positionable relative to (e.g., movable or translatable facilitator(s)) the window and/or door frame. These stationary and/or movable connection points serve as anchor points, providing a secure attachment for the window and/or door within the framed opening. The window and/or door facilitator simplifies the installation process, both from the inside and from the outside, reduces the risk of damage to the structure surrounding the window and/or door, and enhances the lifetime performance of the window and/or door.

In some aspects of the present concepts, a connection facilitator for a fixture (e.g., a replacement window) comprises a base dimensioned for placement adjacent an engagement region or connection region at or near the periphery of the fixture. The facilitator further comprises at least one first connection member or engagement member to facilitate connection of the facilitator to the fixture and includes at least one second connection member by which the facilitator can be directly connected to a structure (e.g., attachment surface of a rough opening) adjacent the fixture. Thus, broadly stated, the present concepts include devices (e.g., a facilitators) connected to or connectable to peripheral portions of a fixture (e.g., replacement window, etc.) to enable connection of the devices (e.g., a facilitators) themselves to the fixture via first connection members at a first portion of the facilitator and to enable connection of the devices to structure (e.g., rough opening) adjacent the fixture via one or more second connection members at a second portion of the facilitator so as to avoid directly inserting mechanical fasteners through the fixture and into the structure (e.g., rough opening) adjacent the fixture.

While certain examples of the facilitators are disclosed by way of example herein, the present concepts expressly include other form factors of connection facilitators for a fixture comprising a base dimensioned for placement adjacent an engagement region or connection region at or near the periphery of the fixture, at least first connection member or engagement member to facilitate connection of the facilitator to the fixture and at least one second connection member by which the facilitator can be directly connected to a structure adjacent the fixture.

For instance, and without limitation, the base could comprise a substantially planar base or an elongated base, the at least one first connection member or engagement member could comprise a component integral with the base or a component that is attachable to and/or removably attachable to the base. In some examples, the second connection member could be associated with an intermediary member connected to the case, rather than being operatively associated with the base. For instance, a second base member (e.g., a bracket or an “L”-shaped bracket) could be attached to the base member, with the at least one second connection member bearing the at least one second connection member (e.g., through holes formed in the second base member). In some examples, the second base member could be positionable or moveable relative to the base member to facilitate positioning for a particular installation, such as to permit some adjustment for the particular structure (e.g., rough opening) adjacent the fixture. Thus, the base member could comprise one or more constituent parts that are, in various aspects, formed as a unit or formed as separable and/or moveable parts that may be assembled and/or adjusted.

The facilitator(s) presented herein introduce a significant advancement in the field of window and/or door installation, offering an improved and efficient method for securing windows and/or doors without the need for drilling through the fixture into a structure (e.g., attachment surface of a rough opening) adjacent the fixture to connect the fixture to the structure and without the need, thereby enhancing performance of the installed fixture and streamlining the installation process.

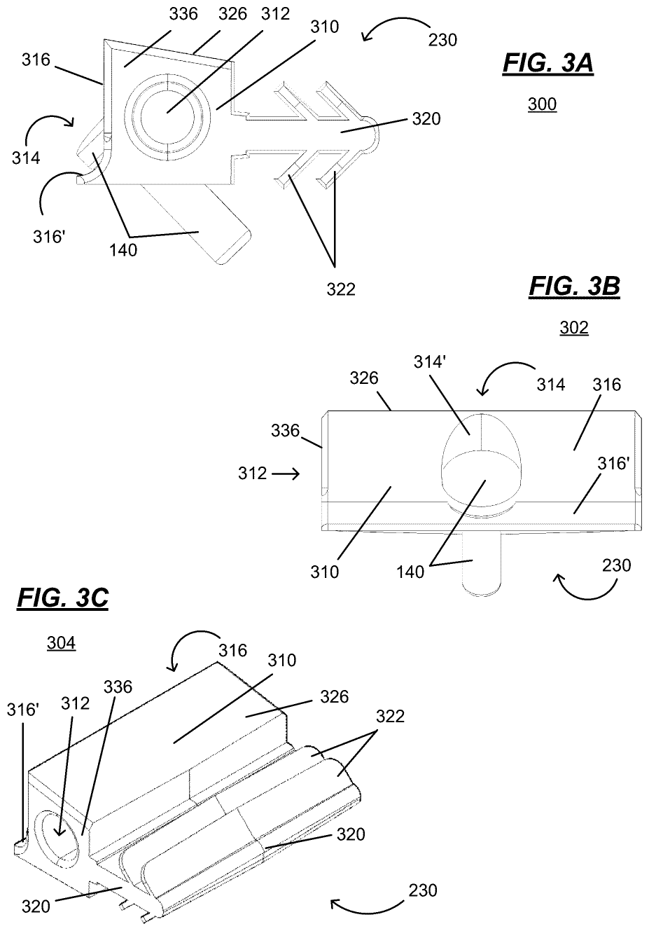

FIG. 3A is an illustration 300 providing an internal side view of the first example of the installation facilitator 230 shown in FIG. 2. FIG. 3B is an illustration 302 providing a front view of the facilitator 230 in accord with at least some aspects of concepts disclosed herein. FIG. 3C is an illustration 304 providing a perspective view of the facilitator 230 in accord with at least some aspects of concepts disclosed herein. FIG. 3A and FIG. 3B and FIG. 3C may be referred to herein collectively as FIG. 3.

In some examples, one or more facilitator(s) (e.g., 230) are positioned in or formed at one or more sides of the window and/or door frame (e.g., one side, two sides, three sides, four sides, or more than four sides, such as for windows having a pentagonal shape, hexagonal shape, etc.). In an example, a facilitator is positioned in, formed at, or fixed to one pre-determined location at one side of a window or door frame. In another example, a facilitator is positioned in, formed at, or fixed to a plurality of locations at one side of a window or door frame. In another example, a facilitator is positioned in, formed at, or fixed to one pre-determined location at a plurality of sides of a window or door frame (e.g., 2 sides, 3 sides, 4 sides, more than 4 sides, etc.). In another example, a plurality of facilitators (2, 3, 4, 5, 6, 7, 8, etc.) are positioned in, formed at, or fixed to a plurality of locations on a plurality of sides of a window or door frame. In the examples depicted in the views of the attached Figures, the example facilitators comprise throughholes. In some examples, a pitch or spacing between facilitators on installation may be about 100 mm (about 4″) center to center. In other aspects of the present concepts, a pitch or spacing of the facilitators may be less (e.g., 25, 50 or 75 mm center to center, or values therebetween) or greater (e.g., 150, 200 or 250 mm center to center, or values therebetween) than that illustrated in the example Figures. In other non-limiting examples, a pitch or spacing of the facilitators is between 25 mm and 250 mm, center to center, values therebetween, or values that are lower than or higher than those indicated. In other aspects, the facilitators may be non-regularly spaced along or at one or more locations on one or more sides of a window or door frame. For example, in one configuration, a plurality of facilitators are provided in a generally clustered grouping at one or more locations on one or more sides of a window or door frame. For instance, such clustered grouping(s) may comprise a smaller pitch or spacing than provided at other portions of the side of a window or door frame. To illustrate, a side of a window frame may comprise a first plurality of facilitators at a first location (e.g., a top portion of a lateral side of the window frame), a second plurality of facilitators at a second location (e.g., a middle portion of the lateral side of the window frame), and a third plurality of facilitators at a third location (e.g., a bottom portion of the lateral side of the window frame) and a pitch or spacing of the first plurality of facilitators or the third plurality of facilitators may be different than (e.g., smaller than, greater than) that of the second plurality of facilitators.

In accord with the disclosure of U.S. Provisional Application 63/515,115, which is incorporated herein by reference in its entirety, in other aspects of the present concepts, one or more positionable facilitator(s) are configured to be positionable relative to one or more sides of the window and/or door frame (e.g., one side, two sides, three sides, four sides, or more than four sides, such as for windows having a pentagonal shape, hexagonal shape, etc.), such as by movement in or on a track or guide along a portion of a length of the one or more sides of the window and/or door frame, movement relative to a portion of a length of the one or more sides of the window and/or door frame, or attachment to one or more sides of the window and/or door frame, etc. In an example, a facilitator is slideable within a track or moveable along a guide member (e.g., a guiderail, etc.) formed along a side of a window or door frame to a position selected by the installer. In one example, a facilitator is configured to be slideable within a track or moveable along a guide member along one side of a window or door frame to a position selected by the installer. In another example, a plurality of facilitators are configured to be slideable within a track or moveable along a guide member along a side of a window or door frame to a position selected by the installer. In another example, one or more facilitators are configured to be slideable within tracks or moveable along guide members along a plurality of sides of a window or door frame to positions selected by the installer. In another example, a plurality of facilitators are configured to be slideable within tracks or moveable along guide members formed in a plurality of sides of a window or door to positions selected by the installer (e.g., 2, 3 or 4 sides of a window or door).

In some examples, a plurality of tracks or guide members are provided on one or more sides of the window and/or door frame (e.g., one side, two sides, three sides, four sides, or more than four sides, such as for windows having a pentagonal shape, hexagonal shape, etc.). These tracks or guide members may be non-contiguous or contiguous along a length of the respective side of the window or door frame, or a portion thereof. For example, a window frame might include, or one or more sides, a plurality of tracks or guide members. In some examples, the tracks or guide members are slightly angled (e.g., 0.25°, 0.5°, 0.75°, 1.0°, etc.) relative to the outer lateral extent of the window frame such that movement of the facilitator along the respective track or guide member positions the facilitator at different depths relative to the outer lateral extent of the window frame and, correspondingly, relative to the window (or door) opening in which the window frame (or door frame) is to be disposed and secured. In this manner, in some aspects of the present concepts, movement of the facilitator can both facilitate leveling of the window frame (or door frame) within the window (or door) opening and facilitate the securement of the window frame (or door frame) to the window (or door) opening.

As noted above, the present disclosure comprises any combinations of elements from both the present disclosure and U.S. Provisional Application 63/515,115. For example, in some examples, a window or door frame comprises one or more selectively positionable facilitators on one side of the window or door frame and one or more fixed facilitators on another side of the window or door frame. In another example, a window or door frame comprises one or more selectively positionable facilitators on one side of the window or door frame and one or more fixed facilitators on a same side of the window or door frame. In another example, a window or door frame comprises one or more selectively positionable facilitators on a plurality of sides of the window or door frame and one or more fixed facilitators on a plurality of other sides of the window or door frame. In another example, a window or door frame comprises one or more selectively positionable facilitators on a plurality of sides of the window or door frame and one or more fixed facilitators on a plurality of other sides of the window or door frame. In another example, a window or door frame comprises one or more selectively positionable facilitators on one side of the window or door frame and one or more fixed facilitators on the same side of the window or door frame. In another example, a window or door frame comprises a plurality of selectively positionable facilitators on one side of the window or door frame and a plurality of fixed facilitators on the same side of the window or door frame.

One notable advantage of the window or door facilitator is its compatibility with various window and door materials, including wood, vinyl, aluminum, fiberglass, composite, and others. This versatility enables its application in residential and commercial settings, making it a valuable solution for a wide range of construction projects.

The adaptability of the window or door facilitator is another remarkable feature. Installers can easily reposition the movable facilitator(s) within the window or door frame and/or select the fixed facilitator(s) positioned at the location(s) the installer deems to be the strongest and most suitable position(s) for attachment. This customization capability ensures optimal installation for different window sizes and requirements. Moreover, the window/door facilitator facilitates consistent force distribution, enhancing the durability and longevity of installed windows.

Additionally, the window facilitator offers the unique advantage of enabling installation or the window or door from either the inside or outside (i.e., from either side of the window or door). This flexibility allows installers to choose the most convenient and efficient approach based on specific installation scenarios. Whether it is a new construction project or a remodeling application, the window facilitator can be employed effectively, saving time and effort.

Furthermore, the window facilitator enhances installation efficiency and convenience. The preformed connection points (e.g., pre-drilled through holes, pilot holes, filled pre-formed through holes, etc.) made available by the facilitator(s), whether fixed and/or movable, significantly reduce installation time and effort, resulting in increased productivity for installers.

As illustrated in FIG. 3, the example facilitator 230 (or “plug”) comprises a facilitator 310 (having a front 316, top 326, and side 336 as shown), an example structural channel 312, an example connection element 314 (with walls 314′ and through which a mechanical fastener 140 is disposed as shown), an optional example lip 316′, and an example engagement member 320 comprising example outwardly extending members 322. In the example facilitator 230 of FIG. 3, the

For various implementations disclosed herein, the installation facilitator comprises a base, an engagement member, and a connection element. The facilitator has a shape conforming at least in part to a corresponding shape of a peripheral portion of a fixture to which the faciliator is to engage to facilitate installation and retention of the fixture. In some aspects, the engagement member couples the facilitator to a selected portion of a feature (e.g., a channel, a flange, etc.) of the fixture. Once the facilitator is disposed at a selected position of the fixture, the facilitator connection element facilitates installation of a fastening component (e.g., nail, screw, etc.) in an appropriate relation to the fixture and an attachment surface (i.e., the exposed surface of the rough opening) adjacent the fixture to affix the facilitator and the fixture relative to the attachment surface.

In some aspects, the engagement member comprises outwardly extending members to help regulate movement of and/or to enhance positional stability of the facilitator within the engagement channel (e.g., anti-rotation, etc.).

In aspects where the connection element comprises a pre-formed (e.g., lines of weakness, pilot holes, etc.) connection point rather than an opening, the pre-formed connection point facilitates alignment of a drill bit, screw, nail or other fastener as the drill bit, screw, nail or other fastener is inserted at an appropriate angle, or range of angles, relative to the attachment surface. In various aspects, the connection element is configured for use with a specific fastening component, such as a nail, a screw, or a self-tapping screw (which bores a hole in the attachment surface ahead of the threaded portion thereof).

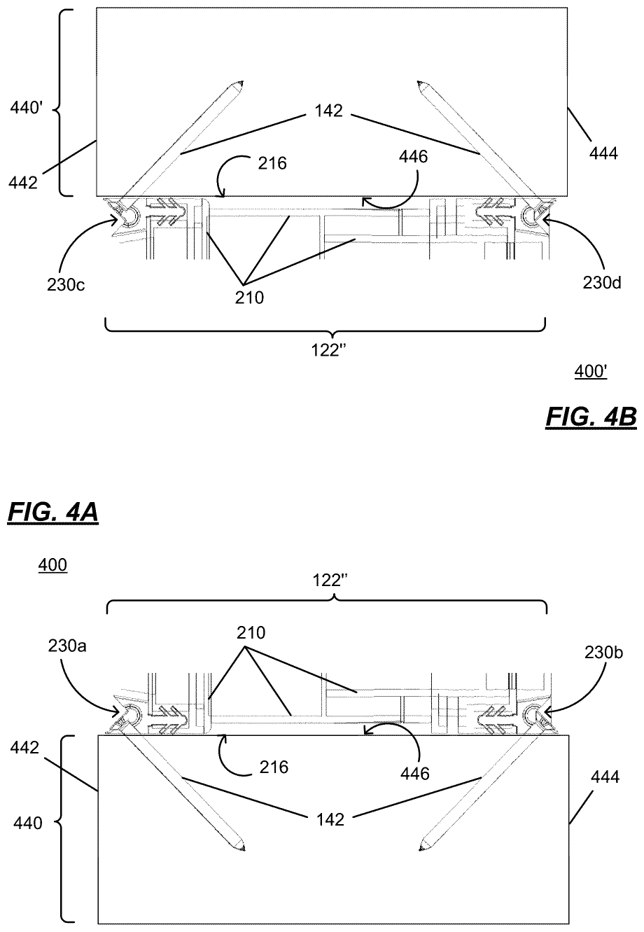

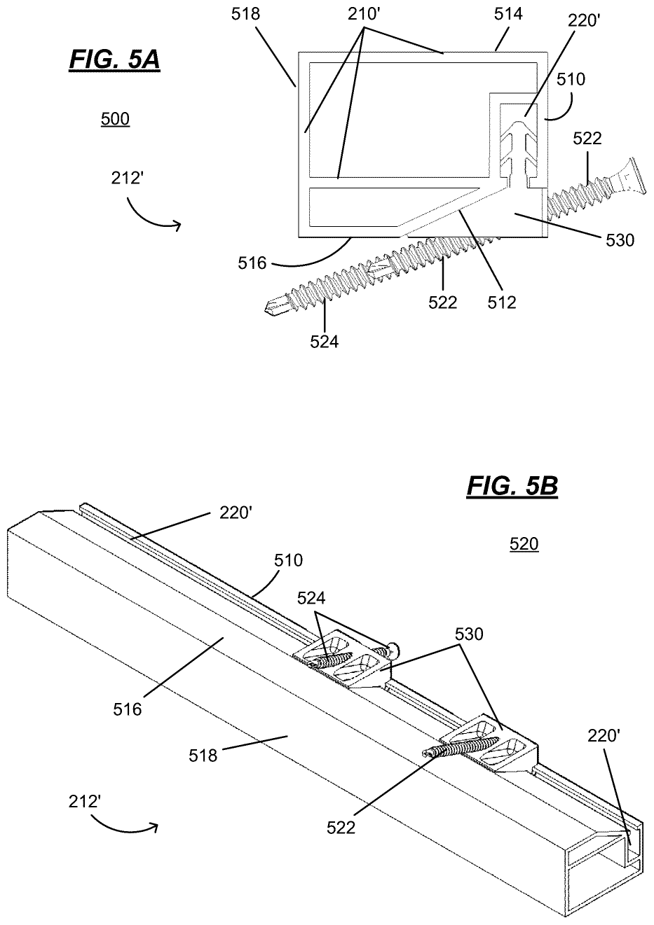

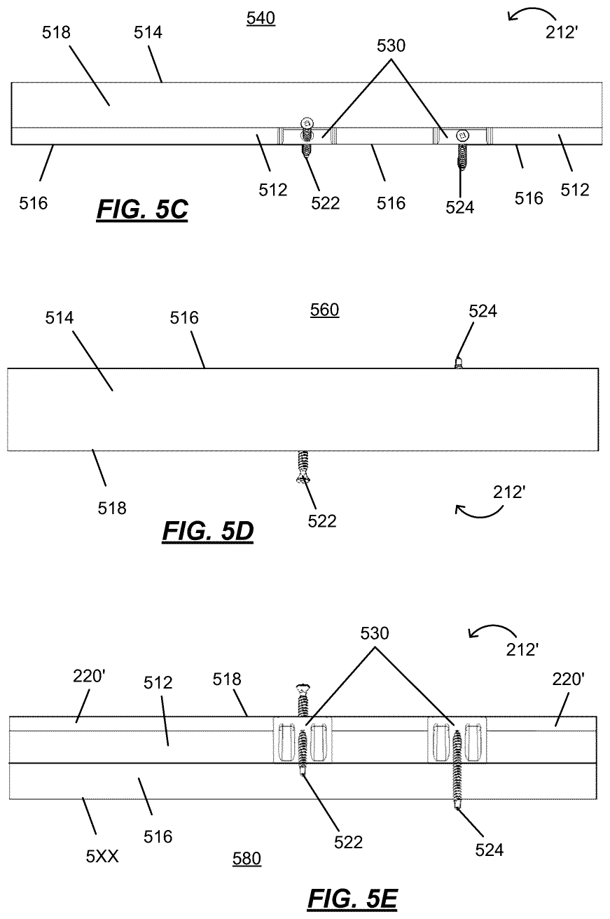

Notably, the engagement member and the engagement channel may be oriented for engagement in a direction parallel to the attachment surface as shown in FIGS. 1-3. Alternatively, the engagement member and the engagement channel instead may be oriented for engagement in a direction perpendicular to the attachment surface as described with regard to FIG. 5 later herein. FIG. 4A is an illustration 400 providing a partial cut-away side view of a dual-facilitator LFP 122″ attached to a structure 440 in accord with at least some aspects of concepts disclosed herein. FIG. 4B is an illustration 400′ providing a partial cut-away side view of a dual-facilitator frame upper portion (FUP) attached to a structure 440 in accord with at least some aspects of concepts disclosed herein. FIG. 4A and FIG. 4B may be referred to herein collectively as FIG. 4. Notably, FIG. 4B is substantially the same as FIG. 4A but inverted to demonstrate that the installation facilitation system disclosed herein may be used on all sides of the frame to engage the attachment surface 446 of the circumscribed opening in which the fixture is to be disposed. As such, all disclosures made herein with regard to an LFP apply equally to an UFP as well as to side frame portions on the left and right.

As shown in FIG. 4, a plurality of fastening components 142 operationally coupled to the facilitator 230a, 230b, 230c, and 230d engage the attachment surface 446 of the structure 440 and 440′, both below and above respectively, to at least partially affix the bottom or top of the fixture 216 to the attachment surface 446 without the need for drilling through the fixture.

FIG. 5A is an illustration 500 providing a side view of an alternative LFP assembly comprising a second example facilitator in accord with at least some aspects of concepts disclosed herein. FIG. 5B is an illustration 520 providing a perspective view of the LFP assembly of FIG. 5A in accord with at least some aspects of concepts disclosed herein. FIG. 5C is an illustration 540 providing an internal side view of the LFP assembly of FIG. 5A in accord with at least some aspects of concepts disclosed herein. FIG. 5D 560 is an illustration providing a top view of the LFP assembly of FIG. 5A in accord with at least some aspects of concepts disclosed herein. FIG. 5E 580 is an illustration providing a bottom view of the LFP assembly of FIG. 5A in accord with at least some aspects of concepts disclosed herein. FIG. 5A, FIG. 5B, FIG. 5C, FIG. 5D, and FIG. 5E may be referred to herein collectively as FIG. 5.

FIG. 5 utilizes a second facilitator, discussed above, with an alternative LFP 212′ and comprises the same basic features such as supports 210′ and an engagement channel 220′. The LFP 212′ also comprising a top 514, bottom 516, front 510, back 518, and an angled surface 512 adjacent to the engagement channel that forms a portion of the facilitator receiver to correspondingly receive a portion of the facilitators 530 having similar primary dimensions so as to provide mating surfaces (e.g., similar or equal angles and dimensions), such as cooperatively formed angled surfaces 512. Also shown are screws 522 and 524.

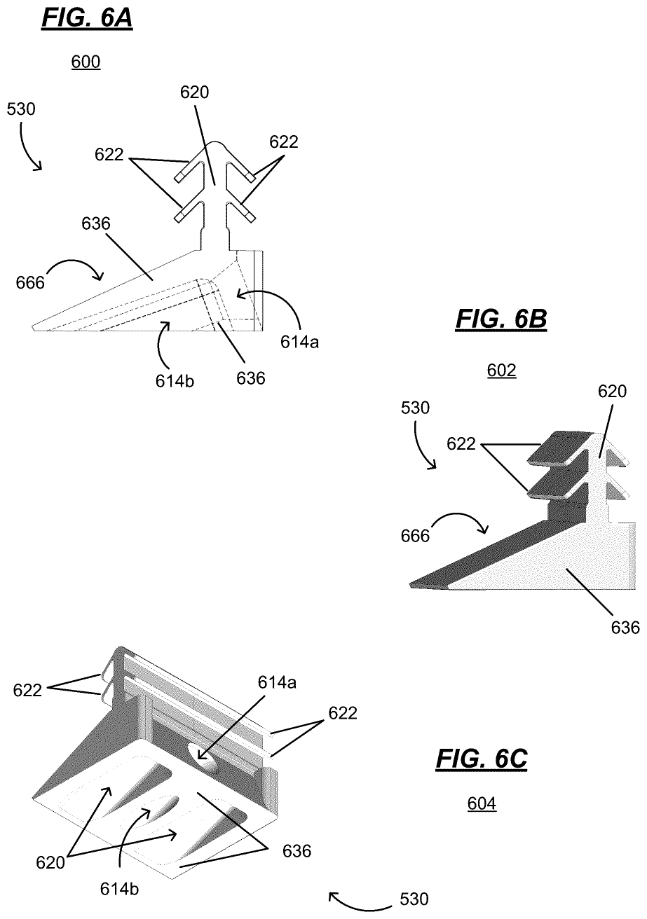

FIG. 6A is an illustration 600 providing a cut-away side view of an example second facilitator in accord with at least some aspects of concepts disclosed herein. FIG. 6B is an illustration 602 providing a partial-perspective side view of the example second facilitator in accord with at least some aspects of concepts disclosed herein. FIG. 6C is an illustration 604 providing an up-from-bottom perspective view of the example second facilitator in accord with at least some aspects of concepts disclosed herein. FIG. 6A, FIG. 6B, and FIG. 6C may be referred to herein collectively as FIG. 6.

As illustrated in FIG. 6, the second facilitator 530 comprises a facilitator 636, a connection element comprising a first opening 614a and a second opening 614b, an angled surface 666 for engaging the angled surface 512 of the LFP, as well as an engagement member 620 comprising outwardly extending members 622 and may also feature structural recesses 620 in the body 636.

In view of the example facilitators disclosed above, various implementations disclosed herein are accordingly directed to an installation facilitation system for a fixture that may comprise: a facilitator receiver functionally external to the fixture and having primary dimensions; an engagement channel operationally positioned within the emplacement receptable; a facilitator conforming to the primary dimensions of the facilitator receiver of the fixture, an engagement member physically coupled to the facilitator for operationally engaging the engagement channel corresponding to the facilitator receiver, and a connection element in the facilitator for enabling a fastening component to engage an attachment surface to at least partially affix the fixture to the attachment surface without drilling through the fixture.

The engagement member also may be laterally slidable within the engagement channel to selectively position the system with regard to both the fixture and the attachment surface. The engagement member may further comprise outwardly extending members for preventing the engagement member from inadvertently disengaging from the engagement channel and/or for preventing the engagement member from inadvertently sliding within the engagement channel absent application of a sliding force. The connection element may also enable a drill to bore a hole in the attachment surface at a set angle relative to said attachment surface and/or also enable the fastening component to engage the attachment surface at a set angle relative to said attachment surface.

The connection element may be configured for a fastening component (e.g., a nail, a screw, and a self-tapping screw, etc.). Regardless, the engagement member and the engagement channel may be oriented for engagement in a direction that is either parallel to or perpendicular to the attachment surface. The fixture may be a door, a window, a door comprising an external door frame and an internal door assembly, and/or a window comprising an external window frame and an internal window assembly. The fixture may comprise an exterior frame and an internal assembly, and/or the exterior frame may incorporate both the facilitator receiver and the engagement channel.

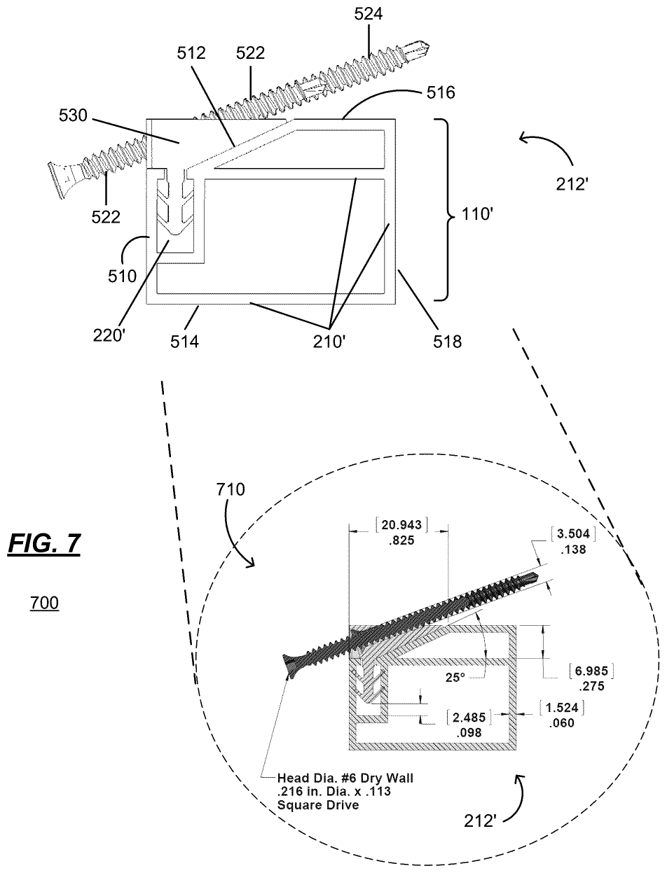

FIG. 7 is an illustration 700 again providing a side view of the alternative LFP assembly 212′ comprising a second facilitator 530 originally shown in FIG. 5A but with an image of a dimensional map 710 incorporated therein to provide exemplary dimensions for said facilitator in accord with at least some aspects of concepts disclosed herein. As shown in said dimensional map 710, values without brackets are given in inches while values within brackets are given in millimeters. As one example, the mechanical fastener may comprise a self-tapping screw #6 screw with a head diameter of 0.216 inches for a 0.113 inch square drive, although nothing in this disclosure is intended to limit the various implementations disclosed herein to any specific subset of sizes or dimensions.

The disclosures above generally feature a facilitator that is separately connected to the frame of the fixture and/or may be slidable within a channel provided by the fixture where the facilitator is connect. However, various alternative implementations may also be directed to a fixed or integrated facilitator that is part-and-parcel of the fixture frame.

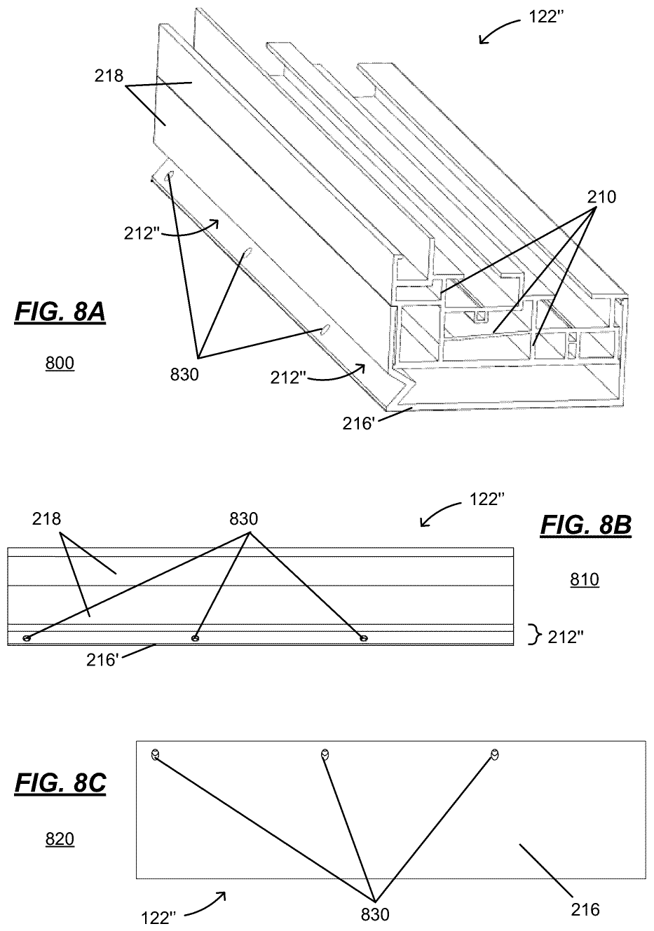

FIG. 8A is an illustration 800 providing a perspective view of an alternative LFP assembly comprising an integrated facilitator in accord with at least some aspects of concepts disclosed herein. FIG. 8B is an illustration 810 providing an internal side view of the alternative LFP of FIG. 8A in accord with at least some aspects of concepts disclosed herein. FIG. 8C is an illustration 820 providing a bottom view of the alternative LFP assembly of FIG. 8A in accord with at least some aspects of concepts disclosed herein. FIG. 8A, FIG. 8B, and FIG. 8C may be referred to herein collectively as FIG. 8. In FIG. 8, the LFP 122″ is similar to LFP 122′ of FIG. 2 but feature a fixed engagement indentation 212 with fixed guides 830 for fastening components.

For any of the several implementations disclosed herein, an exemplary methodology for facilitated installation of a fixture may comprising the following steps: (1) couple a facilitator of a facilitator within a facilitator receiver of the fixture such that an engagement member of the facilitator extending from the facilitator is operationally engaged within an engagement channel corresponding to the facilitator receiver; and (2) install a fastening component through a connection element of the facilitator in the facilitator and physically engaging an attachment surface to at least partially affix the fixture to the attachment surface without drilling through the fixture. Additionally, adjusting a position of the facilitator or the depth of the fastening component may also be utilized to improve square, level, and/or plumb of the fixture.

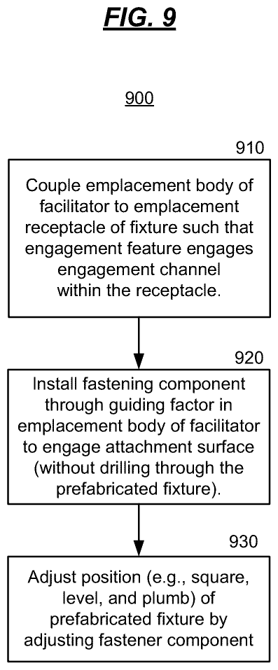

FIG. 9 is a process flow diagram illustrating one example approach for facilitated installation of a fixture representative of the at least some implementations disclosed herein. In FIG. 9, at act 910, the facilitator is coupled to the facilitator receiver of a fixture, such as by inserting an engagement member of the facilitator into an engagement channel of the fixture. Then, at act 920, during installation, a mechanical fastener is installed through the connection element in the facilitator to engage an attachment surface without drilling through the fixture. In some examples, the fixture may be positioned, in act 930, within the opening by adjusting the fastener component and/or moving the fastener component (by moving the facilitator).

In summary, the window and door installation facilitators disclosed herein introduce an innovative solution that dramatically improves the window installation process. By eliminating the need for drilling into the window frame, the installation facilitators disclosed herein offer a more efficient, secure, and customizable method of attaching windows or doors to structures and further enhances the lifetime performance of the installed windows and doors. The compatibility of the installation facilitators with various window and door materials, adaptability to residential and commercial applications, ability to securely fasten at any selected locations make the window and door installation facilitator a valuable addition to the field of window and door installation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Moreover, it will be apparent to one skilled in the art that other implementations may be practiced apart from the specific details disclosed above.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding. Skilled artisans will further appreciate that block diagrams herein can represent conceptual views of illustrative circuitry embodying the principles of the technology, and that any flow charts, state transition diagrams, pseudocode, and the like represent various processes which may be embodied in computer readable medium and so executed by a computer or processor, whether or not such computer or processor is explicitly shown. The functions of the various elements including functional blocks may be provided through the use of dedicated electronic hardware as well as electronic circuitry capable of executing computer program instructions in association with appropriate software. Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims.

In the foregoing description, for purposes of explanation and non-limitation, specific details are set forth—such as particular nodes, functional entities, techniques, protocols, standards, etc.—in order to provide an understanding of the described technology. In other instances, detailed descriptions of well-known methods, devices, techniques, etc. are omitted so as not to obscure the description with unnecessary detail. All statements reciting principles, aspects, embodiments, and implementations, as well as specific examples, are intended to encompass both structural and functional equivalents, and such equivalents include both currently known equivalents as well as equivalents developed in the future, i.e., any elements developed that perform the same function, regardless of structure. For instance, in one variation of the disclosed concepts, a facilitator for a fixture (e.g., a window) comprises a first base portion including a first connection member and a second base portion connectable to the first base portion via a second connection member of the first base portion or the second base portion (or via a first base connection part on the first base portion and mating second base connection part on the second base portion), the second base portion comprising a second connection member by which the second base portion of the facilitator can be directly connected to a structure (e.g., attachment surface of a rough opening) adjacent the fixture.

While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the claims and examples presented below.

Other examples of the present concepts are set forth in the examples listed below.

In example 1, a frame for a window or a door comprises a first track or guide member disposed at a first side of the frame and a first installation facilitator disposed to move along the first track or guide member.

In example 2, for the frame of example 1, a portion of the first installation facilitator is disposed within the first track.

In example 3, the frame of example 2 comprises another installation facilitator movably disposed within the first track.

In example 4, the frame of example 1 further comprises a second track or guide member disposed at a second side of the frame and a second installation facilitator disposed to move along the second track or guide member.

In example 5, for the frame of example 4, a portion of the second installation facilitator is disposed within the second track.

In example 6, the frame of example 5 further comprises another installation facilitator movably disposed within the second track.

In example 7, the frame of example 4 further comprises a third track or guide member disposed at a third side of the frame and a third installation facilitator disposed to move along the third track or guide member.

In example 8, for frame of example 7, a portion of the third installation facilitator is disposed within the third track.

In example 9, the frame of example 5 further comprises another installation facilitator movably disposed within the third track.

In example 10, the frame of example 7 further comprises a fourth track or guide member disposed at a fourth side of the frame and a fourth installation facilitator disposed to move along the fourth track or guide member.

In example 11, for the frame of example 10, a portion of the fourth installation facilitator is disposed within the fourth track.

In example 12, the frame of example 11 further comprises another installation facilitator movably disposed within the fourth track.

In example 13, for the frame of any of examples 1-12, any one or more of the first installation facilitator, second installation facilitator, third installation facilitator and/or fourth installation facilitator, comprise a first angled portion to matingly engage a complementarily angled portion of the frame and comprise a projecting member disposed to extend into a respective one of the first track, the second track, the third track and/or the fourth track.

In example 14, for the frame of any of examples 1-12, any one or more of the first installation facilitator, second installation facilitator, third installation facilitator and/or fourth installation facilitator, comprise a first angled portion to matingly engage a complementarily angled portion of the frame and comprise a base member extending in a first direction and one or more outwardly extending members extending outwardly in a second direction different than the first direction.

In example 15, for the frame of any of examples 1-14, the frame is a window frame.

In example 16, a frame for a window or a door comprises a first installation facilitator disposed at a first side of the frame, wherein the first installation facilitator comprises as least one preformed connection point.

In example 17, for the frame of example 16, the as least one preformed connection point of the first installation facilitator comprises a pre-drilled through hole, a pilot hole, or a filled pre-formed through hole.

In example 18, for the frame of example 17, the as least one preformed connection point of the first installation facilitator comprises a plurality of preformed connection points, each of the plurality of preformed connection points comprising a pre-drilled through hole, a pilot hole or a filled pre-formed through hole, and the plurality of preformed connection points may be of the same construction or wherein at least one of the plurality of preformed connection points is of a different construction than at least one other of the plurality of preformed connection points.

In example 19, the frame of example 16 further comprises a second installation facilitator disposed at a second side of the frame, wherein the second installation facilitator comprises as least one preformed connection point.

In example 20, for the frame of example 19, the as least one preformed connection point of the second installation facilitator comprises a pre-drilled through hole, a pilot hole, or a filled pre-formed through hole.

In example 21, for the frame of example 20, the as least one preformed connection point of the second installation facilitator comprises a plurality of preformed connection points, each of the plurality of preformed connection points comprising a pre-drilled through hole, a pilot hole or a filled pre-formed through hole, and the plurality of preformed connection points may be of the same construction or wherein at least one of the plurality of preformed connection points is of a different construction than at least one other of the plurality of preformed connection points.

In example 22, the frame of example 19, further comprises a third installation facilitator disposed at a third side of the frame, wherein the third installation facilitator comprises as least one preformed connection point.

In example 23, for the frame of example 22, the as least one preformed connection point of the third installation facilitator comprises a pre-drilled through hole, a pilot hole, or a filled pre-formed through hole.

In example 24, for the frame of example 23, the as least one preformed connection point of the third installation facilitator comprises a plurality of preformed connection points, each of the plurality of preformed connection points comprising a pre-drilled through hole, a pilot hole or a filled pre-formed through hole, and the plurality of preformed connection points may be of the same construction or wherein at least one of the plurality of preformed connection points is of a different construction than at least one other of the plurality of preformed connection points.

In example 25, the frame of example 22 further comprises a fourth installation facilitator disposed at a fourth side of the frame, wherein the fourth installation facilitator comprises as least one preformed connection point.

In example 26, for the frame of example 25, the as least one preformed connection point of the fourth installation facilitator comprises a pre-drilled through hole, a pilot hole, or a filled pre-formed through hole.

In example 27, for the frame of example 26, the as least one preformed connection point of the fourth installation facilitator comprises a plurality of preformed connection points, each of the plurality of preformed connection points comprising a pre-drilled through hole, a pilot hole or a filled pre-formed through hole, and wherein the plurality of preformed connection points may be of the same construction or wherein at least one of the plurality of preformed connection points is of a different construction than at least one other of the plurality of preformed connection points.

In example 28, for the frame of any of examples 16-27, the frame is a window frame.

In example 29, the frame of any of examples 16-27 further comprises a first track or guide member disposed at the first side of the frame; and a first movable installation facilitator disposed to move along the first track or guide member.

In example 30, for the frame of example 29, a portion of the first movable installation facilitator is disposed within the first track.

In example 31, the frame of example 30 further comprises another movable installation facilitator movably disposed within the first track.

In example 32, the frame of example 29 further comprises a second track or guide member disposed at the second side of the frame and a second movable installation facilitator disposed to move along the second track or guide member.

In example 33, for the frame of example 32, a portion of the second movable installation facilitator is disposed within the second track.

In example 34, the frame of example 33, further comprises another movable installation facilitator movably disposed within the second track.

In example 35, the frame of example 32 further comprises a third track or guide member disposed at the third side of the frame and a third movable installation facilitator disposed to move along the third track or guide member.

In example 36, for the frame of example 35, a portion of the third movable installation facilitator is disposed within the third track.

In example 37, the frame of example 36 further comprises another movable installation facilitator movably disposed within the third track.

In example 38, the frame of example 35 further comprises a fourth track or guide member disposed at the fourth side of the frame and a fourth movable installation facilitator disposed to move along the fourth track or guide member.

In example 39, for the frame of example 38, a portion of the fourth movable installation facilitator is disposed within the fourth track.

In example 40, the frame of example 39 further comprises another movable installation facilitator movably disposed within the fourth track.

In example 41, for the frame of any of examples 16-40, any one or more of the first movable installation facilitator, second movable installation facilitator, third movable installation facilitator and/or fourth movable installation facilitator, comprise a first angled portion to matingly engage a complementarily angled portion of the frame and comprise a projecting member disposed to extend into a respective one of the first track, the second track, the third track and/or the fourth track.

In example 42, for the frame of any of examples 16-40, any one or more of the first movable installation facilitator, second movable installation facilitator, third movable installation facilitator and/or fourth movable installation facilitator, comprise a first angled portion to matingly engage a complementarily angled portion of the frame and comprise a base member extending in a first direction and one or more outwardly extending members extending outwardly in a second direction different than the first direction.

In example 43, for the frame of any of examples 16-42, the first installation facilitator comprises a plurality of spaced apart preformed connection points disposed along at least a portion of the first side of the frame.

In example 44, for the frame of any of examples 16-43, the second installation facilitator comprises a plurality of spaced apart preformed connection points disposed along at least a portion of the second side of the frame.

In example 45, for the frame of any of examples 16-44, the third installation facilitator comprises a plurality of spaced apart preformed connection points disposed along at least a portion of the third side of the frame.

In example 46, for the frame of any of examples 16-45, the fourth installation facilitator comprises a plurality of spaced apart preformed connection points disposed along at least a portion of the fourth side of the frame.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. A facilitator apparatus for an installation facilitation system for a fixture, comprising:
a base;
a first connection element to connect the base to a portion of a peripheral portion of the fixture; and
a second connection element to connect the facilitator to an attachment surface adjacent the fixture.

2. The apparatus of claim 1, wherein the first connection element comprises an engagement member extending outwardly from the base and into the fixture.

3. The apparatus of claim 2, wherein the engagement member is laterally slidable within an engagement channel of the fixture to enable selective positioning of the apparatus along at least a portion of a side of the fixture.

4. The apparatus of claim 1, wherein the second connection element comprises an opening or a through hole at a set angle relative to the base or relative to the attachment surface adjacent the fixture.

5. The apparatus of claim 1, wherein the base comprises a first base portion comprising the first connection element and a second base portion comprising the second connection element.

6. The apparatus of claim 5, wherein the first base portion and the second base portion are different portions of a unitary base.

7. The apparatus of claim 5, wherein the first base portion and the second base portion are separable portions connectable to one another via a base connector or via a plurality of mating base connector elements.

8. The apparatus of claim 1, wherein the second connection element comprises one or more through holes or one or more lines of weakness extending at least partially through the base.

9. The apparatus of claim 5, wherein the second connection element of the second base portion comprises one or more through holes or one or more lines of weakness extending at least partially through the base.

10. The apparatus of claim 1, wherein the base comprises a first angled portion to at least substantially matingly engage a complementarily angled portion of the fixture.

11. The apparatus of claim 1, wherein the fixture comprises a window casing.

12. An installation facilitation system for a fixture, comprising:
a fixture comprising one or more engagement regions at or near a periphery of the fixture; and
a facilitator comprising a base, a first connection element to connect the base to a portion of a peripheral portion of the fixture and a second connection element to connect the facilitator to an attachment surface adjacent the fixture.

13. The system of claim 12, wherein the first connection element of the facilitator comprises an engagement member extending outwardly from the base and into the fixture.

14. The system of claim 13, wherein the engagement member is laterally slidable within an engagement channel of the fixture to enable selective positioning of the apparatus along at least a portion of a side of the fixture.

15. The system of claim 12, wherein the second connection element comprises an opening or a through hole at a set angle relative to the base or relative to the attachment surface adjacent the fixture.

16. The system of claim 12, wherein the base comprises a first base portion comprising the first connection element and a second base portion comprising the second connection element.

17. The system of claim 16, wherein the first base portion and the second base portion are separable portions connectable to one another via a base connector or via a plurality of mating base connector elements.

18. The system of claim 16, wherein the second connection element comprises one or more through holes or one or more lines of weakness extending at least partially through the base.

19. A method for preparing a fixture for installation, the method comprising:
coupling one or more installation facilitators to a corresponding one or more peripheral portions of a fixture, each of the one or more installation facilitators comprising a base, a first connection element to connect the base to a peripheral portion of the fixture and a second connection element to connect the facilitator to an attachment surface adjacent the fixture.

20. The method of claim 19, further comprising:
installing the fixture in a rough opening;
disposing the second connection element of the facilitator in a selected position relative to attachment surfaces of the rough opening adjacent the fixture; and
inserting mechanical fasteners through the second connection element to secure the facilitator to the attachment surfaces of the rough opening adjacent.
